(19) United States
(12) Patent Application Publication
(10) Pub. No.: US 2009/0236109 A1
(43) Pub. Date: Sep. 24, 2009

(54) Power tool having a temperature indicator

(76) Inventors: Shuming Wu, Nanjing (CN); Yasheng Chen, Nanjing (CN)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/383,104

(22) Filed: Mar. 19, 2009

(30) Foreign Application Priority Data
Mar. 21, 2008 (CN) 200810020008.9

(51) Int. Cl. B23Q 17/09; G01K 1/02; B25F 5/00

(52) U.S. Cl. 173/20; 116/216; 374/E01.002

(57) ABSTRACT

The present invention relates to a power tool including a temperature indicator. The power tool includes a housing, a driving source, a transmission system within the housing, a working head connected to the transmission system through a connecting means, and a temperature indicator mounted on the parts of the power tool that may increase in temperature during operation, thereby warning the operator not to touch the specific part, and/or turn off the power tool to potentially prolong the life of the effected part.

### CROSS-REFERENCE TO RELATED APPLICATIONS

This application claims priority under 35 U.S.C. 119 to Chinese Patent Application No. 200810020008.9, filed on Mar. 21, 2008, which is incorporated herein by reference.

### FEDERALLY SPONSORED RESEARCH OR DEVELOPMENT

Not Applicable.

### TECHNICAL FIELD

The present invention relates to a power tool and more particularly to a working head portion having a temperature indicator.

### BACKGROUND OF THE INVENTION

An electric power tool is a commonly used power tool, generally comprising a motor. During the operation, the rotation of the motor drives a transmission mechanism, and the transmission mechanism drives a working head (bit, drill, saw, etc.) of the electric power tool to machine an object.

During the operation, multiple parts of the body of the electric power tool may increase in temperature due to the continuous movement of the moving components within the body. The two main heat sources are the motor and the transmission mechanism. Although many electric power tools comprise a ventilation system therein, the heat generated within the body during the continuous operation cannot be completely eliminated. Heat accumulates within the body, which may cause the body to get hot to the touch, and should be avoided by the user.

During continuous operation, the working head will also experience an increase in temperature due to the friction between the working head and the object. The working head is attached to the power tool through an attachment or connecting means for receiving the working head. The attachment means may also experience an increase in temperature during operation. During operation, the working head may be replaced frequently by the user, because of wear of the working head or different requirements for working heads with different shapes and sizes. The user may not notice the high temperature of the working head and the attachment or connecting means, so he or she may easily be hurt when replacing the working head.

In addition, the motor may get hot due to long time operation of the electric power tool or potentially due to a malfunction. Under such circumstances, if the electric power tool is continuously worked, the motor may be damaged, or the life of the motor may be affected with the increase in temperature.

Therefore, there is a need to monitor the temperature of the power tool, and in particular, the motor and working head of the power tool, to avoid potential harm to the user or damage to the power tool.

### SUMMARY OF THE INVENTION

In one embodiment, the present invention discloses a power tool comprising a housing, a driving source, a transmission system mounted within the housing that can be driven by the driving source, and a working head connected to the transmission system. A temperature indicator is mounted on the power tool.

In another embodiment, the invention discloses a power tool comprising a housing, a driving source, a transmission system located within the housing that can be driven by the driving source, and a working head connected to the transmission system through a connecting means. A temperature indicator is mounted on at least one of the connecting means and the working head.

In yet another embodiment, the present invention discloses a power tool comprising a housing, a motor mounted within the housing, a transmission system within the housing to be driven by the motor, and a working head connected to the transmission system. A temperature indicator is mounted on the outer surface of the motor. The housing comprises a transparent part corresponding to the position of the temperature indicator.

In another embodiment, the present invention discloses a working head for a power tool comprising a temperature indicator positioned on the working head.

In the present invention, the temperature change of the power tool and the working head can be reflected through the temperature indicator, which can give a reading or a warning to the user about the temperature of the affected part of the power tool. The operating safety of the power tool is improved, and the service life of the power tool and the working head is prolonged.

### BRIEF DESCRIPTION OF THE DRAWINGS

The subject power tool and its working head will become apparent from the following detailed description and accompanying drawings.

FIG. 1 is a schematic view of a first embodiment of the present invention applied to a reciprocating saw.

FIG. 2 is a schematic view of a second embodiment of the present invention applied to a circular saw.

FIG. 3 is a schematic view of a third embodiment of the present invention applied to a drill.

### DETAILED DESCRIPTION

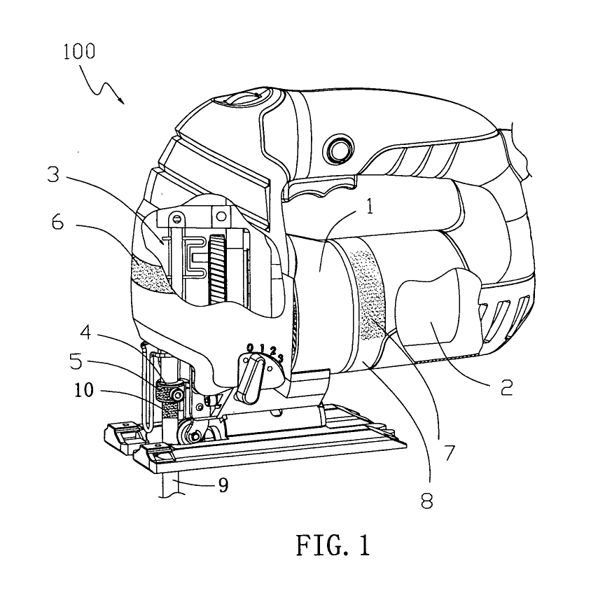

FIG. 1 shows a first embodiment of the present invention applied to a reciprocating saw 100. The reciprocating saw 100 comprises a housing 1, a motor 2 mounted within the housing 1 and a transmission system 3. A working head, such as a blade 9 is connected to the transmission system 3 through an attachment or a clamping means 4. The motor 2 drives the transmission system 3 to make the blade 9 move in a reciprocating manner. The structures of the reciprocating saw 100 are well-known, so it will not be described in detail here. The housing 1 is a case or a shell containing the motor 2, the transmission system 3 and other working components. The housing 1 may be an integrated style or divided sections.

Referring to FIG. 1, temperature indicators 5, 10 are mounted on the clamping means 4 and the blade 9 of the reciprocating saw 100 respectively. The temperature indicator 10 on the blade 9 is preferably located on the non-cutting portion, or at least a portion of the blade which is not in contact with the cutting surface. In addition, temperature indicators 6, 7 are respectively mounted on the different parts of the housing 1 corresponding to the location of the transmission system 3 and the location of the motor 2 therein.

Alternatively, in other embodiments, the temperature indicator 7 may be located directly on the outer surface of the motor 2. The part of the housing 1 corresponding to the location of the motor 2 may include a transparent part 8. The user can observe the temperature indicator 7 through the transparent part 8 of the housing 1. When the temperature of the motor 2 is beyond a certain value, the service life of the motor may be affected. Thus, when the user finds the temperature of the motor 2 is higher than the normal value by observing the temperature indicator 7 through the transparent part 8, he or she can interrupt the operation to reduce the load on the motor 2.

After the reciprocating saw 100 is working for some time, the temperature of the blade 9 may rise because of the friction between the blade 9 and the workpiece (not shown), which will cause the temperature of the clamping apparatus 4 to rise. Further, as the motor 2 and transmission system 3 increase in temperature due to the prolonged operation, the temperature of the parts of the housing 1 corresponding to the motor 2 and the transmission system 3 will rise accordingly. When the temperature rises to a certain value, the temperature indicators 5, 6, 7, 10 will send out warning information to remind the user not to touch the hot parts, which provides improved operating safety. In addition, the temperature indicator 10 on the blade 9 has another function. When the temperature of the blade 9 is beyond a certain value, the temperature indicator 10 will send out warning information to the user that the cutting temperature is beyond a predetermined value. Preferably, when this happens the user should interrupt the operation or replace the blade 9 to reduce the wear.

In an alternate embodiment, the temperature indicator 7 is mounted on the outer surface of the motor 2. After the reciprocating saw 100 is operating for an extended time, the temperature of the motor 2 will rise and the temperature indicator 7 will send out warning information. The user can observe the reading of the temperature indicator 7 through the transparent part 8 of the housing 1, and determine the temperature of the motor 2. Based on this information, the operator can interrupt or slow down the cutting operation to lower the temperature of the motor 2 and prolong the service life of the motor 2.

Various thermal sensing/indicating materials useful in the present invention are known in the art. The temperature indicator 5, 6, 7, 10 may be any material, system or mechanical device that can read or reflect the temperature change. Examples include an infrared sensing temperature indicating device, a thermal resistance temperature indicating device, a bimetallic temperature indicating device, and so on. Additional economical and easy-to-read indicators may include a thermal sensing coating formed with thermal sensing material, a chip including the thermal sensing material, or the material of the structures of the electric power tool mixed with the thermal sensing material directly.

In one embodiment of the present invention, a thermal sensing coating is applied. The color of the thermal sensing material changes according to the temperature. Different thermal sensing materials sense different temperature values, and show different colors. Some materials change their color gradually as the temperature rises. Therefore, for different parts of the electrical power tool and different requirements, the appropriate thermal sensing material may be applied. For example, material which is sensitive to a desired minimum temperature may be applied to the temperature indicators 5, 6, 7 on the housing 1 and the clamping or attachment means 4. The temperature indicator 10 on the blade 9 may be made from the same material, which is sensitive to the desired minimum temperature under which the blade 9 wears down easily or has the color change gradually in accordance with the temperature. The temperature indicator 7 on the motor 2 may be made from material which is sensitive to the minimum temperature under which the motor 2 is easily damaged. Preferably, the thermal sensing material of the temperature indicators 5, 6, 7, 10 is reversible, wherein the starting color returns as the temperature lowers. In other embodiments, the temperature indicators 5, 6, 7, 10 may be chips, including thermal sensing material, wherein the chips can be replaced.

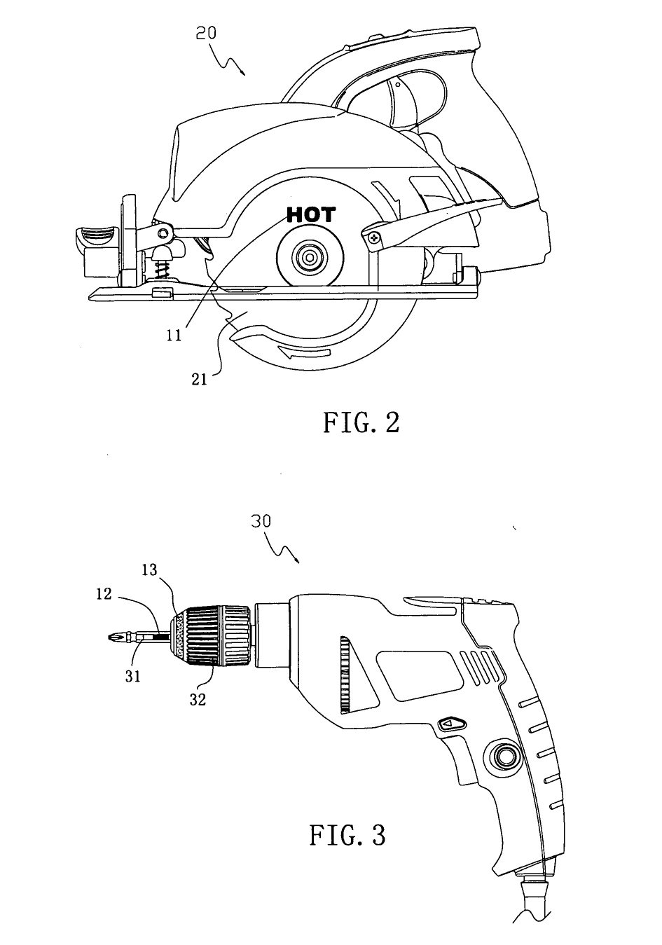

In addition to the reciprocating saw 100 shown in the FIG. 1, the present invention can be applied to a variety of electric power tools and the working heads mounted thereon. Referring to FIGS. 2 and 3, in the second and third embodiments, temperature indicators 11, 12, 13 are mounted on a blade 21 of a circular saw 20, a bit 31, and a chuck 32 of a drill 31, respectively.

The temperature indicator 11 in FIG. 2 is embodied as letters or symbols, which will become very striking when the color changes. In the present embodiment, the letters are “HOT.” In other embodiments, the temperature indicator 11 may be a pointer, a scale or a buzzer, which can show and warn of a high temperature.

The temperature indicators 11, 12 are preferably mounted on the non-cutting portion of the blade 21 of the circular saw and the bit 31 of the drill. Furthermore, the temperature indicator may be mounted on the outer surface of the motor and the gear case of the circular saw 20 and the drill 30, which is similar to the reciprocating saw 100.

In another embodiment, the temperature indicator is made from a thermal sensing material. The thermal sensing material will preferably show a striking color, which is clearly distinguished from the color of the housing of the electric power tool to facilitate identification after the temperature of the thermal sensing material rises.

The present invention is not limited to the power tools shown in FIGS. 1 to 3, but can be applied to a variety of power tools and the working heads that are prone to getting hot during use. The working head can be described as an operating part that directly acts on a work piece, such as a bit, a saw blade, a circular blade, a milling cutter, a grinding disc, a hammer head, and so on. In addition to the electric power tools mentioned above, the present invention can be applied to power tools supplied with other power sources, for example pneumatic power tools.

The present invention is not restricted as the embodiments disclosed hereinabove. Accordingly, any substitutes and modifications according to the spirit of the present invention will be regarded as falling within the claims appended hereto.

What is claimed is:

1. A power tool comprising:
a housing;
a driving source;
a transmission system within the housing, which can be driven by the driving source;
a working head connected to the transmission system;
a temperature indicator mounted on the at least one of the housing, transmission system and working head; and,
wherein at least one of the housing, transmission system and working head is subject to an increase in temperature when the driving source is actuated, activating the temperature indicator.

2. The power tool of claim 1, wherein the driving source is a motor located within the housing.

3. The power tool of claim 1, wherein the temperature indicator comprises thermal sensing material, the color of which changes as the temperature rises.

4. The power tool of claim 3, wherein the temperature indicator is embodied as letters or symbols.

5. The power tool of claim 3, wherein the color of the thermal sensing material is clearly distinguished from the color of the region of the housing covered by the thermal sensing material after the temperature rises.

6. The power tool of claim 3, wherein the thermal sensing material is reversible.

7. The power tool of claim 3, wherein the temperature indicator is replaceable.

8. A power tool comprising:
a housing;
a driving source;
a transmission system within the housing, which is driven by the driving source;
a working head connected to the transmission system through a connecting means; and,
a temperature indicator mounted on at least one of the connecting means and the working head.

9. The power tool of claim 8, wherein the driving source is a motor located within the housing.

10. The power tool of claim 8, wherein the temperature indicator comprises thermal sensing material, the color of which changes as the temperature rises.

11. The power tool of claim 10, wherein the temperature indicator is embodied as letters or symbols.

12. The power tool of claim 10, wherein the color of the thermal sensing material is clearly distinguished from the color of the region of the housing covered by the thermal sensing material after the temperature rises.

13. The power tool of claim 10, wherein the thermal sensing material is reversible.

14. The power tool of claim 10, wherein the temperature indicator is replaceable.

15. A power tool comprising:
a housing;
a motor mounted within the housing;
a transmission system within the housing, which is driven by the motor, a working head connected to the transmission system; and
a temperature indicator mounted on the outer surface of the motor, and the housing further comprising a transparent part corresponding to the position of the temperature indicator.

16. The power tool of claim 15, wherein the temperature indicator comprises thermal sensing material, the color of which changes after the temperature rises.

17. The power tool of claim 16, wherein the color of the thermal sensing material is clearly distinguished from the color of the region of the housing covered by the thermal sensing material after the temperature rises.

18. The power tool of claim 16, wherein the thermal sensing material is reversible.

19. A working head for a power tool comprising a temperature indicator.

20. The working head for a power tool of claim 19, wherein the temperature indicator is mounted on the non-working portion of the working head.

21. The working head for a power tool of claim 19, wherein the temperature indicator comprises thermal sensing material, the color of which changes as the temperature rises.

22. The working head for a power tool of claim 21, wherein the temperature indicator is a thermal sensing coating including the thermal sensing material.

23. The working head for a power tool of claim 21, wherein the temperature indicator is embodied as letters or symbols.

24. The working head for a power tool of claim 21, wherein the color of the thermal sensing material is clearly distinguished from the color of the region of the housing covered by the thermal sensing material after the temperature rises.

25. The working head for a power tool of claim 21, wherein the thermal sensing material is reversible.

26. The working head for a power tool of claim 21, wherein the temperature indicator is replaceable.
